(19) United States
(12) Patent Application Publication
(10) Pub. No.: US 2025/0182370 A1
(43) Pub. Date: Jun. 5, 2025

(54) METHOD FOR LIGHTWEIGHTING TEXT-TO-IMAGE GENERATION MODEL BASED ON SELF-ATTENTION KNOWLEDGE DISTILLATION AND APPARATUS FOR THE SAME

(71) Applicant: ELECTRONICS AND TELECOMMUNICATIONS RESEARCH INSTITUTE, Daejeon (KR)

(72) Inventors: Youngwan LEE, Sejong-si (KR); Kwanyong PARK, Daejeon (KR); Yong-Ju LEE, Daejeon (KR)

(21) Appl. No.: 18/952,010

(22) Filed: Nov. 19, 2024

(30) Foreign Application Priority Data
Nov. 30, 2023 (KR) 10-2023-0170453
Aug. 29, 2024 (KR) 10-2024-0116781

(51) Int. Cl. G06T 15/00; G06F 40/58

(52) U.S. Cl. CPC G06T 15/00; G06F 40/58

(57) ABSTRACT

Disclosed herein are a method for lightweighting a text-to-image generation model based on self-attention knowledge distillation and an apparatus for the same. A method for lightweighting a text-to-image generation model based on self-attention knowledge distillation is performed by an apparatus for lightweighting a text-to-image generation model, and includes constructing a lightweight model by pruning and changing a part of blocks in the text-to-image generation model, and training the lightweight model based on self-attention knowledge distillation using a teacher model.

### CROSS REFERENCE TO RELATED APPLICATIONS

This application claims the benefit of Korean Patent Application Nos. 10-2023-0170453, filed Nov. 30, 2023 and 10-2024-0116781, filed Aug. 29, 2024, which are hereby incorporated by reference in their entireties into this application.

### BACKGROUND OF THE INVENTION

### 1. Technical Field

The present disclosure relates generally to technology for generating an image from text in a generative AI field, and more particularly to technology for generating a lightweight model capable of rapidly generating an image by applying a knowledge distillation method to a stable diffusion XL model (SDXL) that is the focus of current interest.

### 2. Description of Related Art

A recent large text-to-image generation model improves the performance, but results in burdens on the size of the model (a storage size) and a processing speed. For example, referring to FIG. 1, a stable diffusion (SD) model has 860M-scale parameters, but the recently disclosed stable diffusion XL model (SDXL) has parameters extended to 2.6 B scale.

Referring to FIG. 2, a stable diffusion model 200 is largely divided into a text encoder part, a U-Net part, and an image decoder part, and the U-Net part 210 has the largest number of parameters. The U-Net part 210 repeats a text-embedded vector by n times (e.g., 50) to perform a denoising process, and this process may be called as a key part for providing the principle of the diffusion model in which an image is generated from random noises.

In this way, a U-Net model 220, the most important part to generate an image, rapidly increases in size and thus the quality of image generation is enhanced. However, as the number of weights and processing time of the model increase that much, a technology for improving such burdens is required.

### PRIOR ART DOCUMENTS

### Patent Documents

(Patent Document 1) Korean Patent Application Publication No. 10-2023-0072454, Date of Publication: May 24, 2023 (Title: Apparatus, Method and Program for Bidirectional Generation Between Image and Text)

### SUMMARY OF THE INVENTION

Accordingly, the present disclosure has been made keeping in mind the above problems occurring in the prior art, and an object of the present disclosure is to provide a method and apparatus for generating a lightweight model for generating an image from text, the lightweight model having the more excellent quality of image generation and an improved speed than an existing lightweight model.

Another object of the present disclosure is to provide a method and apparatus for ensuring the maximum quality of image generation and shortening the time required for image generation by twice or more of the existing lightweight model through compression of a model for generating an image from text based on knowledge distillation.

A further object of the present disclosure is to provide a method and apparatus for constructing a compression model in which a portion of a transformer block occupying the largest portion of parameters of a U-Net is pruned, the U-Net being an internal neural network structure of a model for generating an image from text.

Yet another object of the present disclosure is to provide a method and apparatus for freezing the weights of an SDXL model that is a knowledge distillation teacher model, and then transferring a self-attention feature map among intermediate feature maps generated in the teacher model to a compression model and training the compression model.

In accordance with an aspect of the present disclosure to accomplish the above objects, there is provided a method for lightweighting a text-to-image generation model, the method being performed by an apparatus for lightweighting a text-to-image generation model, the method including constructing a lightweight model by pruning and changing a part of blocks in the text-to-image generation model; and training the lightweight model based on self-attention knowledge distillation using a teacher model.

Each of the text-to-image generation model and the teacher model may correspond to a transformer-based diffusion model including a self-attention operation.

Constructing the lightweight model may include pruning a pair of one residual block and one transformer block group from a DOWN-2 stage and a DOWN-3 stage corresponding to an encoder part, and an UP-1 stage and an UP-2 stage corresponding to a decoder part in a denoising U-Net model that is an internal neural network structure of the text-to-image generation model; and changing a transformer block group included in each of the DOWN-3 stage, an MID stage and the UP-1 stage of the denoising U-Net model to a transformer block group having a reduced depth.

The lightweight model may correspond to any one of a KD-SDXL-1B model changed to a transformer block group having a depth of 6 and a KD-SDML-700M model changed to a transformer block group having a depth of 5.

Training the lightweight model may include, after freezing weights of the teacher model, extracting feature maps for respective stages of the teacher model, and then transferring the feature maps to the lightweight model.

Training the lightweight model may further include training the lightweight model based on a mean square error (MSE) loss function so as to minimize a loss value calculated for the feature maps.

Transferring the feature maps may include extracting the feature map from a final block constituting each of a DOWN-1 stage and an UP-3 stage of the denoising U-Net model, and extracting the feature map from a self-attention layer of a transformer block group in each of stages other than the DOWN-1 stage and the UP-3 stage.

Transferring the feature maps may further include extracting the feature maps by selecting transformer blocks corresponding to a size of the reduced depth from each of the transformer block groups of the teacher model in the DOWN-3 stage, the MID stage, and the UP-1 stage of the denoising U-Net model.

Transferring the feature maps may further include extracting the feature maps by sequentially selecting the transformer blocks corresponding to the size of the reduced depth starting from a first block among the transformer blocks constituting the transformer block group.

The loss value may correspond to a sum of a first loss value corresponding to a result of a comparison between a noise generated by the lightweight model and a ground truth noise, a second loss value corresponding to a result of a comparison between noises of the teacher model and the lightweight model, and a third loss value corresponding to a result of a comparison between mean square values of differences between the feature maps extracted from the teacher model and the feature maps extracted from the lightweight model.

In accordance with another aspect of the present disclosure to accomplish the above objects, there is provided an apparatus for lightweighting a text-to-image generation model, including a processor configured to construct a lightweight model by pruning and changing a part of blocks in a text-to-image generation model, and train the lightweight model based on self-attention knowledge distillation using a teacher model; and memory configured to store the teacher model and the lightweight model.

Each of the text-to-image generation model and the teacher model may correspond to a transformer-based diffusion model including a self-attention operation.

The processor may be configured to prune a pair of one residual block and one transformer block group from a DOWN-2 stage and a DOWN-3 stage corresponding to an encoder part, and an UP-1 stage and an UP-2 stage corresponding to a decoder part in a denoising U-Net model that is an internal neural network structure of the text-to-image generation model, and change a transformer block group included in each of the DOWN-3 stage, an MID stage and the UP-1 stage of the denoising U-Net model to a transformer block group having a reduced depth.

The lightweight model may correspond to any one of a KD-SDXL-1B model changed to a transformer block group having a depth of 6 and a KD-SDML-700M model changed to a transformer block group having a depth of 5.

The processor may be configured to, after freezing weights of the teacher model, extract feature maps for respective stages of the teacher model, and then transfer the feature maps to the lightweight model.

The processor may be configured to train the lightweight model based on a mean square error (MSE) loss function so as to minimize a loss value calculated for the feature maps.

The processor may be configured to extract the feature map from a final block constituting each of a DOWN-1 stage and an UP-3 stage of the denoising U-Net model, and extract the feature map from a self-attention layer of a transformer block group in each of stages other than the DOWN-1 stage and the UP-3 stage.

The processor may be configured to extract the feature maps by selecting transformer blocks corresponding to a size of the reduced depth from each of the transformer block groups of the teacher model in the DOWN-3 stage, the MID stage, and the UP-1 stage of the denoising U-Net model.

The processor may be configured to extract the feature maps by sequentially selecting the transformer blocks corresponding to the size of the reduced depth starting from a first block among the transformer blocks constituting the transformer block group.

The loss value may correspond to a sum of a first loss value corresponding to a result of a comparison between a noise generated by the lightweight model and a ground truth noise, a second loss value corresponding to a result of a comparison between noises of the teacher model and the lightweight model, and a third loss value corresponding to a result of a comparison between mean square values of differences between the feature maps extracted from the teacher model and the feature maps extracted from the lightweight model.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating an example in which an existing stable diffusion (SD) model is compared with a recently disclosed SDXL model;

FIG. 2 is a diagram illustrating a typical example structure of the SD model;

FIG. 3 is an operation flowchart illustrating a method for lightweighting a text-to-image generation model based on self-attention knowledge distillation according to an embodiment of the present disclosure;

FIGS. 4 and 5 are diagram illustrating examples of a U-Net knowledge distillation process of a text-to-image generation model according to the present disclosure;

FIGS. 6 and 7 are diagrams illustrating examples of a process for matching a self-attention feature map within a transformer block group according to the present disclosure;

FIG. 8 is a diagram illustrating an example in which an image generated using a lightweight model generated through the present disclosure is compared with an image generated through an existing text-to-image generation model;

FIG. 9 is a diagram illustrating a structure for generating a lightweight model through an apparatus for lightweighting a text-to-image generation model according to the present disclosure; and

FIG. 10 is a diagram illustrating an apparatus for lightweighting a text-to-image generation model based on self-attention knowledge distillation according to an embodiment of the present disclosure.

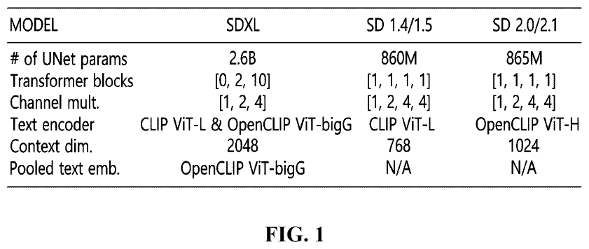

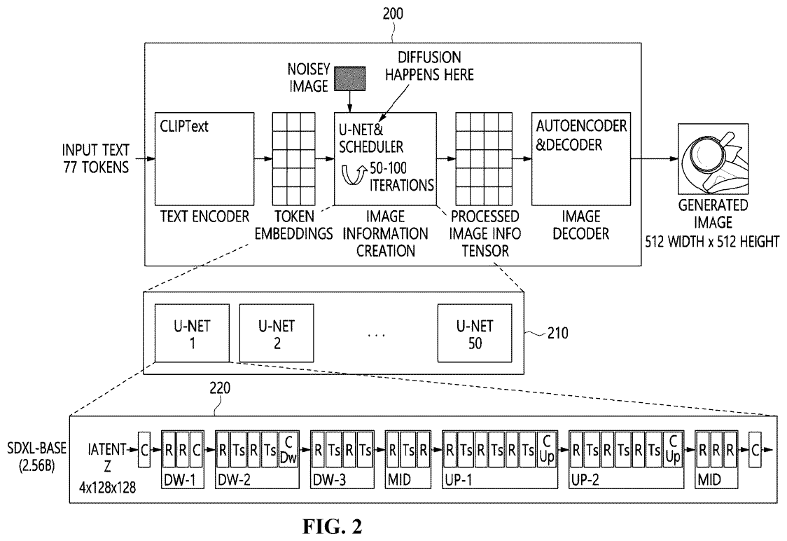

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Hereinafter, embodiments of the present disclosure will be described in detail with reference to the attached drawings.

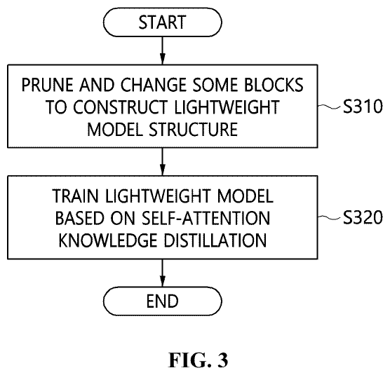

FIG. 3 is an operation flowchart illustrating a method for lightweighting a text-to-image generation model based on self-attention knowledge distillation according to an embodiment of the present disclosure.

Referring to FIG. 3, in the method for lightweighting a text-to-image generation model based on self-attention knowledge distillation according to an embodiment of the present disclosure, an apparatus for lightweighting a text-image model prunes and changes some of blocks in the text-to-image generation model to constructs a lightweight model at step S310.

Here, the text-to-image generation model may correspond to a transformer-based diffusion model including a self-attention operation.

Typically, a portion occupying the largest number of calculations and model parameters (about 74%) in the diffusion model-based text-to-image generation model exactly corresponds to a denoising U-Net part.

Therefore, the present disclosure may first prune some blocks in a U-Net model of the text-to-image generation model or change some blocks to blocks having a low depth to construct a lightweight model.

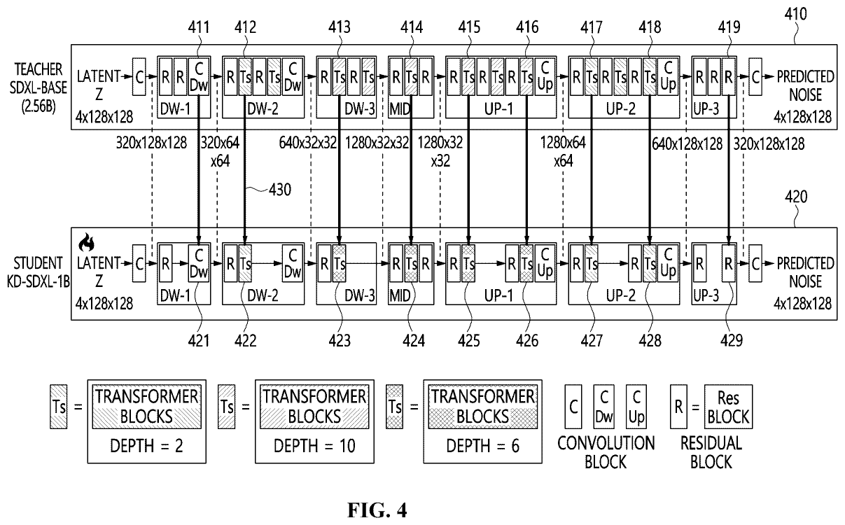

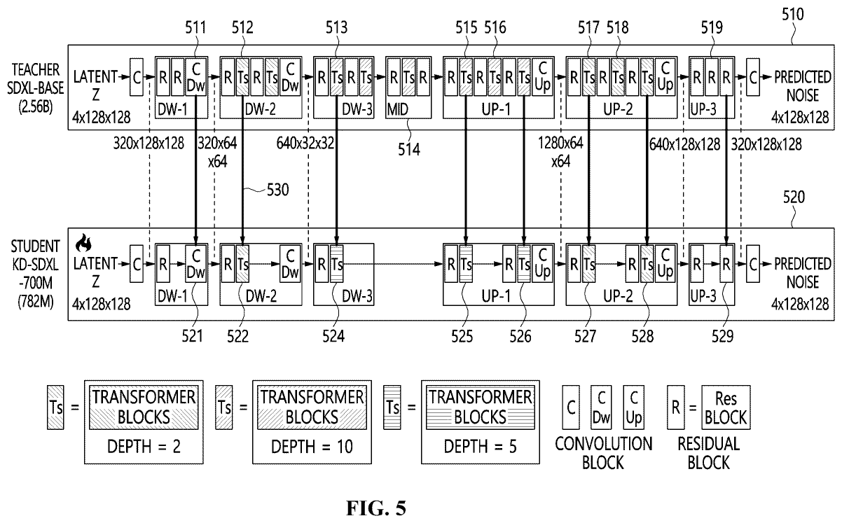

For example, as illustrated in FIGS. 4 and 5, some blocks may be pruned or changed in teacher models 410 and 510 based on a U-Net model of the SDXL model to induce a KD-SDXL-1B model and KD-SDXL-700M model that are lightweight models 420 and 520.

First, each of the teacher models 410 and 510 based on the U-Net model of the SDXL model may include a transformer block having a depth of 2, a transformer block having a depth of 10, a convolution block, a residual block, and the like.

Here, in the denoising U-Net model that is an internal neural network structure of the text-to-image generation model, a pair including one residual block and one transformer block group may be pruned from a DOWN-2 stage and a DOWN-3 stage correspond to an encode part, and an UP-1 stage and an UP-2 stage corresponding to a decoder part.

For example, in FIG. 4, when the structures of the teacher model 410 corresponding to the SDXL model and the lightweight model 420 corresponding to the KD-SDXL-1B model are compared with each other, the residual blocks corresponding to RES blocks are pruned from the DOWN-1 stage and UP-3 stage. In addition, lightweighting is performed by pruning a pair including one residual block and one transformer block group from the DOWN-2 stage, the DOWN-3 stage, the UP-1 stage, and the UP-2 stage.

For another example, in FIG. 5, when the structures of the teacher model 510 corresponding to the SDXL model and the lightweight model 520 corresponding to the KD-SDXL-700M model are compared with each other, lightweighting is performed by pruning a residual block and a transformer block group, in the same manner as the example illustrated in FIG. 4, and additionally pruning the whole MID stage.

Here, transformer block groups respectively included in the DOWN-3 stage, the MID stage, and the UP-1 stage of the denoising U-Net model may be changed to transformer block groups having reduced depths.

Here, the lightweight model may correspond to any one of the KD-SDXL-1B model changed to a transformer block group having a depth of 6 and the KD-SDML-700M model changed to a transformer block group having a depth of 5.

For example, referring to FIG. 4, the total number of model parameters of the U-Net model of the SDXL model, which is the teacher model 410, is about 2.56 B, and a spot having the largest number of parameters among the U-Net model is transformer block groups 413, 414 and 415 each having a depth of 10 in {DW-3, MID, UP-1} stages. Accordingly, in the present disclosure, the transformer block groups 413, 414 and 415 having a depth of 10 in the {DW-3, MID, UP-1} stages may be respectively changed to transformer block groups 423, 424, 425 and 426 having a depth of 6 to reduce the number of parameters and the computational load.

For another example, FIG. 5 illustrates the lightweight model 520 corresponding to the KD-SDXL-700B model in which the number of parameters and the computational load are further reduced than the lightweight model 420 corresponding to the U-Net model of the KD-SDXL-1B model. That is, the transformer block groups 513, 515 and 516 having a depth of 10 in the {DW-3, UP-1} stages of the teacher model 510 may be respectively changed to transformer block groups 523, 525 and 526 having a depth of 5 to reduce the number of parameters and the computational load. In addition, unlike the KD-SDXL-1B lightweight model 420 illustrated in FIG. 4, the MID stage 514 itself is pruned from the KD-SDXL-700B lightweight model 520 illustrated in FIG. 5 and thus all blocks included therein may be considered to be pruned.

Finally, according to the present disclosure, the KD-SDXL-1B lightweight model 420 may have 1.16 B parameters, and the KD-SDXL-700M lightweight model 520 may have 782M parameters.

In addition, in the method for lightweighting a text-to-image generation model based on self-attention knowledge distillation according to an embodiment of the present disclosure, the apparatus for lightweighting a text-image model trains a lightweight model based on the self-attention knowledge distillation using a teacher model at step S320.

Here, the teacher model may also correspond to a transformer-based diffusion model including a self-attention operation.

Here, the weights of the teacher model may be frozen, and then feature maps for respective stages of the teacher model may be extracted and transferred to the lightweight model.

Namely, the image generation capability of the teacher model may be transferred to a student model by defining the U-Net model of the SDXL model as the teacher model and the lightweight U-Net model as the student model, and then performing knowledge distillation-based training from the teacher model to the student model.

Here, it is important what feature map is extracted from each stage and transferred to the lightweight model, and the following method is proposed in the present disclosure.

Here, the feature maps may be respectively extracted from final blocks included in the DOWN-1 stage and the UP-3 stage of the denoising U-Net model, and from self-attention layers of the transformer block groups included in stages other than the DOWN-1 stage and the UP-3 stage.

For example, referring to FIGS. 4 and 5, the feature maps may be extracted from final blocks 411, 419, 421, 429, 511, 519, 521 and 529 in the DW-1 and UP-3 stages of each model, and the feature maps may be extracted from transformer block groups 412 to 418, 422 to 428, 512 to 518, and 522 to 528 in DW-2, DW-3, MID, UP-1 and UP-2 stages other than the DW-1 and UP-3 stages.

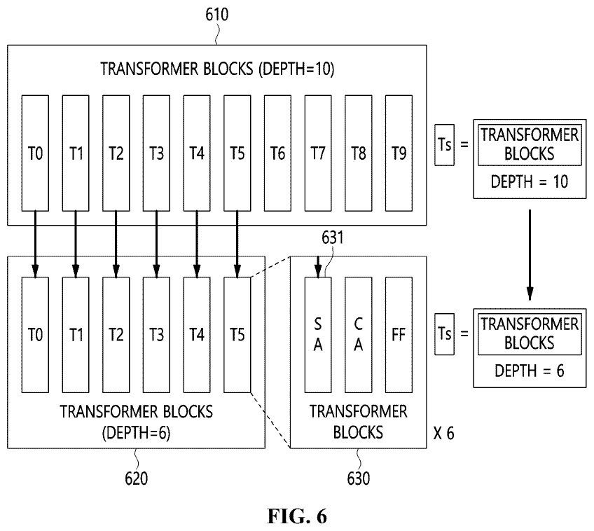

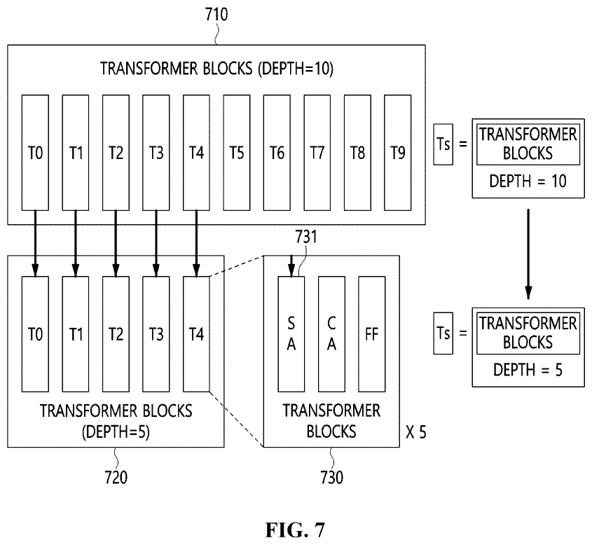

Here, referring to FIGS. 6 and 7, the transformer blocks 630 and 730 constituting the transformer block groups respectively include self-attention (SA) layers 631 and 731, cross-attention (CA) layers, feed-forward (FF) network layers, and from among the layers, only the SA layers 631 and 731 are extracted to be used in the knowledge distillation-based training in the present disclosure. Namely, the feature map of the SA layer may be extracted.

Here, in the DOWN-3, MID and UP-1 stages of the denoising U-Net model, transformer blocks corresponding to a reduced depth size may be selected from each of the transformer block groups of the teacher model to extract the feature maps.

For example, regarding the KD-SDXL-1B lightweight model 420 illustrated in FIG. 4, the transformer block groups 423 to 426 included in the DW-3, MID, and UP-1 stages have a depth of 6 and thus include six transformer blocks like the transformer block group 620 illustrated in FIG. 6. However, the transformer block groups 413 to 416 included in the DW-3, MID, and UP-1 stages have a depth of 10 and thus include ten transformer blocks like the transformer block group 610 illustrated in FIG. 6. Accordingly, in the present disclosure, six transformer blocks may be selected from among the ten transformer blocks T0 to T9 included in the transformer block group 610, and the feature maps of the self-attention layers may be extracted therefrom.

For another example, regarding the KD-SDXL-700M lightweight model 520 illustrated in FIG. 5, the transformer block groups 523 to 526 included in the DW-3 and UP-1 stages have a depth of 5 and thus include five transformer blocks like a transformer block group 720 illustrated in FIG. 7. However, the transformer block groups 513, 515 and 516 included in the DW-3 and UP-1 stages have a depth of 10 and thus include ten transformer blocks like the transformer block group 710 illustrated in FIG. 7. Accordingly, in the present disclosure, five transformer blocks may be selected from among the ten transformer blocks T0 to T9 included in the transformer block group 710, and the feature maps of the self-attention layers may be extracted therefrom.

Here, since transformer block groups 412, 418, 422, 428, 512, 518, 522 and 528 have a depth of 2 in the DW-2 and UP-2 layers of each model illustrated in FIGS. 4 and 5, the feature maps of the self-attention layers may be extracted from every two transformer blocks constituting each transformer block group.

Here, transformer blocks corresponding to the reduced depth size may be sequentially selected starting from the first block among the transformer blocks constituting the transformer block group and the feature maps may be extracted. For example, as illustrated in FIG. 6, when according to the KD-SDXL-1B lightweight model, only six transformer blocks are selected from the transformer block group 610 including the ten transformer blocks T0 to T9, the six transformer blocks starting from TO corresponding to the first block may be sequentially selected to extract the feature maps of the self-attention layers 631.

For another example, as illustrated in FIG. 7, when only five transformer blocks in conformity with the KD-SDXL-700M lightweight model are selected from the transformer block group 710 including the ten transformer blocks T0 to T9, the five transformer blocks starting from TO corresponding to the first block may be sequentially selected to extract the feature maps of the self-attention layers 731.

Here, the lightweight model may be trained based on a mean square error (MSE) loss function so as to minimize a loss value calculated for the feature map.

That is, in the present disclosure, even though the U-Net model of the SDXL model becomes lightweight, the lightweight model may be trained by applying a loss function so as to output the same result as a U-Net model of an existing SDXL model.

Here, the loss value may correspond to the sum of a first loss value corresponding to the result of a comparison between noise generated by the lightweight model and a ground truth noise, a second loss value correspond to the result of a comparison between noises of the teacher model and the lightweight model, and a third loss value corresponding to the result of a comparison between mean square values of the differences between the feature maps extracted from the teacher model and the feature maps extracted from the lightweight model.

For example, the first loss value may be obtained by applying a loss function of Lₜₐₛₖ as the following Equation (1) so that the lightweight U-Net model according to the present disclosure may output the same result as the ground truth noise (ε_{GT}).

$${L}_{task} = MSE ( {ε}_{GT} - {ε}_{stu} ) \qquad ( 1 )$$

Here, εₛₜᵤ means the output result of the lightweight U-Net model, and the loss value is obtained using a mean square error (MSE) loss function.

For another example, the second loss value may be obtained by applying a loss function of L_{outKD} as the following Equation (2) so that the lightweight U-Net model according to the present disclosure may output the same result as the U-Net model of the existing SDXL model that is considered as a teacher model.

$${L}_{outKD} = MSE ( {ε}_{tea} - {ε}_{stu} ) \qquad ( 2 )$$

Here, εₜₑₐ may mean the output result of the U-Net model of the existing SDXL model.

Here, the U-Net model of the existing SDXL model that is a teacher model may be frozen so that the weights are not updated.

For another example, the third loss value may be obtained by extracting the feature maps of a teacher model and the lightweight model (namely, a student model) in each stage of the U-Net model in each stage of the U-Net model and applying a loss function L_{featKD} as the following Equation (3) so that the lightweight U-Net model imitates better the U-Net model of the existing SDXL model. The lightweight model may be trained to minimize the loss value calculated in this way.

$${L}_{featKD} = MSE ( {f}_{tea} - {f}_{stu} ) \qquad ( 3 )$$

Here, fₜₑₐ and fₛₜᵤ mean sets of the feature maps respectively extracted from the stages, and the loss value may be calculated using the MSE loss function.

Accordingly, a final loss function L_{final} used in training the lightweight model may be as the following Equation (4) obtained by mixing the above-described three loss functions.

$${L}_{final} = {L}_{task} + {L}_{outKD} + {L}_{featKD} \qquad ( 4 )$$

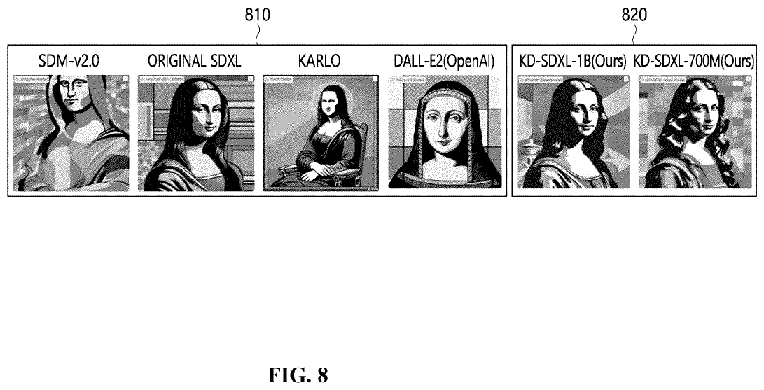

Through the above-described process, in comparison with the typical technology, an excellent image generation result may be obtained and a high resolution image 1024×1024) may be generated more than twice as fast as the SDXL model even using a GPU (VRAM 8 GB) with limited resources. The details related to this may be checked through Table 1 and FIG. 8.

TABLE 1

| | | | | | | KD-SDXL- |
|---|---|---|---|---|---|---|
| | SDM-v2.0 | SDXL | Karlo | DALL-E 2 | KD-SDXL-1B | 700M |
| Image | 1.37 | 6.43 | 4.00 | 10.57 | 3.6 | 2.87 |
| generation | | | | | | |
| speed | | | | | | |
| (seconds) | | | | | | |
| Number of | Total 1255.8M | Total 2740.0M | N/A | N/A | Total 1333.7M | Total 955.4M |
| parameters | (U-Net 865.9M) | (U-Net 2567.5M) | | | (U-Net 1161.2M) | (U-Net 782.8M) |
| (M) | | | | | | |

Through the method for lightweighting a text-to-image generation model, a model for generating an image from text may become lightweight to provide a lightweight model having the more excellent quality of image generation and improved speed than the existing lightweight model.

In addition, through compressing a model for generating an image from text based on knowledge distillation, the maximum quality of image generation may be ensured and an image may be generated more than twice as fast.

In addition, a compression model may be constructed in which a portion of a transformer block having the largest number of parameters of a U-Net is pruned, the U-Net being an internal neural network structure of a model for generating an image from text.

In addition, the present disclosure may freeze the weights of an SDXL model that is a knowledge distillation teacher model, and then transfer a self-attention feature map among intermediate feature maps generated in the teacher model to a compression model and train the compression model.

FIG. 9 is a diagram illustrating a structure for generating a lightweight model through an apparatus for lightweighting a text-to-image generation model according to the present disclosure.

Referring to FIG. 9, in order to generate the lightweight model, when a text-to-image generation model corresponding to a transformer-based diffusion model including a self-attention operation is input to the apparatus for lightweighting a text-to-image generation model according to the present disclosure, a lightweight text-to-image generation model may be output according to the process illustrated in FIG. 3.

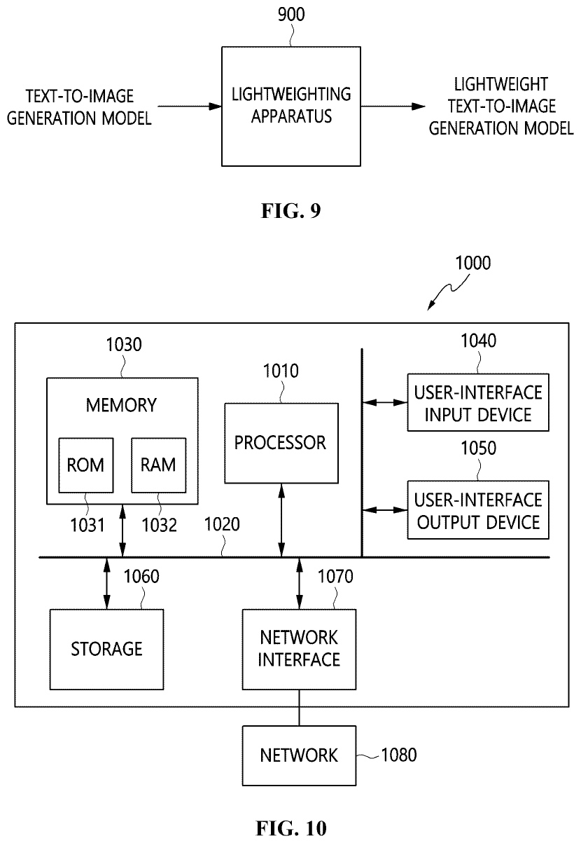

Hereinafter, a detailed description of the operation of the apparatus for lightweighting a text-to-image generation model according to the present disclosure will be provided with reference to FIG. 10.

FIG. 10 illustrates an apparatus for lightweighting a text-to-image generation model based on self-attention knowledge distillation according to an embodiment of the present disclosure.

Referring to FIG. 10, the apparatus for lightweighting a text-to-image generation model based on self-attention knowledge distillation according to an embodiment of the present disclosure may be implemented in a computer system such as a computer-readable storage medium. As illustrated in FIG. 10, the apparatus 1000 for generating a text-to-image generation model may include one or more processors 1010, memory 1030, a user interface input device 1040, a user interface output device 1050, and storage 1060, which communicate with each other through a bus 1020. The apparatus 1000 for generating a text-to-image generation model may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be any of various types of volatile or nonvolatile storage media. For example, the memory 1030 may include Read-Only Memory (ROM) 1031 or Random Access Memory (RAM) 1032.

Therefore, the embodiment of the present disclosure may be implemented as a non-transitory computer-readable medium in which a computer-implemented method or computer-executable instructions are stored. When the computer-readable instructions are executed by the processor, the computer-readable instructions may perform the method according to at least one aspect of the present disclosure.

The processor 1010 prunes or changes some blocks from the text-to-image generation model to construct the lightweight model.

Here, the text-to-image generation model may correspond to a transformer-based diffusion model including a self-attention operation.

Here, in the denoising U-Net model that is an internal neural network structure of the text-to-image generation model, a pair including one residual block and one transformer block group may be pruned from a DOWN-2 stage and a DOWN-3 stage corresponding to an encode part, and an UP-1 stage and an up-2 stage corresponding to a decoder part.

Here, transformer block groups respectively included in the DOWN-3 stage, the MID stage, and the UP-1 stage of the denoising U-Net model may be changed to transformer block groups having a reduced depth.

Here, the lightweight model may correspond to any one of the KD-SDXL-1B model changed to a transformer block group having a depth of 6 and a KD-SDML-700M model changed to a transformer block group having a depth of 5.

In addition, the processor 1010 trains the lightweight model based on self-attention knowledge distillation using a teacher model.

Here, the teacher model may also correspond to a transformer-based diffusion model including a self-attention operation.

Here, the weights of the teacher model may be frozen, and then feature maps for respective stages of the teacher model may be extracted and transferred to the lightweight model.

Here, in the DOWN-1 stage and the UP-3 stage of the denoising U-Net model, the feature maps may be respectively extracted from the final blocks included in the stages, and in stages other than the DOWN-1 stage and the UP-3 stage, the feature maps may be respectively extracted from the self-attention layers of the transformer block group.

Here, in the DOWN-3, MID and UP-1 stages of the denoising U-Net model, transformer blocks corresponding to the reduced depth size may be selected from each transformer block group of the teacher model to extract the feature maps.

Here, transformer blocks corresponding to the reduced depth size may be sequentially selected starting from the first block among the transformer blocks constituting the transformer block group and the feature maps may be extracted.

Here, the lightweight model may be trained based on a mean square error (MSE) loss function in order to minimize a loss value calculated for the feature map.

Here, the loss value may correspond to the sum of a first loss value corresponding to the result of a comparison between noise generated by the lightweight model and a ground truth noise, a second loss value correspond to the result of a comparison between noises of the teacher model and the lightweight model, and a third loss value corresponding to the result of a comparison between mean square values of the differences between the feature maps extracted from the teacher model and the feature maps extracted from the lightweight model.

Here, the detailed operation process of the processor 1010 is described above with reference to FIG. 3, and thus detailed description thereof will be omitted in FIG. 10.

As described above, the memory 1030 stores various pieces of information generated from the apparatus for lightweighting a text-to-image generation model based on self-attention knowledge distillation according to an embodiment of the present disclosure.

According to the embodiment, the memory 1030 may be a component provided independently of the apparatus for lightweighting a text-to-image generation model to support functions for lightweighting the text-to-image generation model based on self-attention knowledge distillation. Here, the memory 1030 may function as separate mass storage, or may include a control function for performing operations.

Meanwhile, the apparatus for lightweighting a text-to-image generation model may be equipped with memory to store information in the apparatus. In an embodiment, the memory may be a computer-readable medium. In an embodiment, the memory may be a volatile memory unit, and in another embodiment, the memory may be a nonvolatile memory unit. In an embodiment, a storage device may be a computer-readable medium. In various different embodiments, the storage device may be, for example, a hard disk device, an optical disk device, or another type of mass storage device.

By means of the apparatus for lightweighting a text-image generation model, a model for generating an image from text may become lightweight to provide a lightweight model having the more excellent quality and improved speed of image generation than the existing lightweight model.

In addition, through compression of a model for generating an image from text based on knowledge distillation, the maximum quality of image generation may be ensured and the image may be generated more than twice as fast.

In addition, a compression model may be constructed in which a portion of a transformer block occupying the largest number of parameters of a U-Net is pruned, the U-Net being an internal neural network structure of a model for generating an image from text.

In addition, the present disclosure may freeze the weights of an SDXL model that is a knowledge distillation teacher model, and then transfer a self-attention feature map among intermediate feature maps generated in the teacher model to a compression model and train the compression model.

According to the present disclosure, the model for generating an image from text may become lightweight to provide a lightweight model having the more excellent quality and improved speed of image generation than the existing lightweight model.

In addition, the present disclosure may ensure the maximum image generation quality and shorten the time required for image generation by twice or more of the existing lightweight model through compression of a model for generating an image from text based on knowledge distillation.

In addition, the present disclosure may construct a compression model in which a portion of a transformer block occupying the largest number of parameters of a U-Net is pruned, the U-Net being an internal neural network structure of a model for generating an image from text.

In addition, the present disclosure may freeze the weights of an SDXL model that is a knowledge distillation teacher model, and then transfer a self-attention feature map among intermediate feature maps generated in the teacher model to a compression model and train the compression model.

As described above, in the method for lightweighting text-to-image generation model based on self-attention knowledge distillation and the apparatus for the method according to the present disclosure, the configurations and schemes in the above-described embodiments are not limitedly applied, and some or all of the above embodiments can be selectively combined and configured so that various modifications are possible.

What is claimed is:

1. A method for lightweighting a text-to-image generation model, the method being performed by an apparatus for lightweighting a text-to-image generation model, the method comprising:
constructing a lightweight model by pruning and changing a part of blocks in the text-to-image generation model; and
training the lightweight model based on self-attention knowledge distillation using a teacher model.

2. The method of claim 1, wherein each of the text-to-image generation model and the teacher model corresponds to a transformer-based diffusion model including a self-attention operation.

3. The method of claim 2, wherein constructing the lightweight model comprises:
pruning a pair of one residual block and one transformer block group from a DOWN-2 stage and a DOWN-3 stage corresponding to an encoder part, and an UP-1 stage and an UP-2 stage corresponding to a decoder part in a denoising U-Net model that is an internal neural network structure of the text-to-image generation model; and
changing a transformer block group included in each of the DOWN-3 stage, an MID stage and the UP-1 stage of the denoising U-Net model to a transformer block group having a reduced depth.

4. The method of claim 3, wherein the lightweight model corresponds to any one of a KD-SDXL-1B model changed to a transformer block group having a depth of 6 and a KD-SDML-700M model changed to a transformer block group having a depth of 5.

5. The method of claim 3, wherein training the lightweight model comprises:
after freezing weights of the teacher model, extracting feature maps for respective stages of the teacher model, and then transferring the feature maps to the lightweight model.

6. The method of claim 5, wherein training the lightweight model further comprises:
training the lightweight model based on a mean square error (MSE) loss function so as to minimize a loss value calculated for the feature maps.

7. The method of claim 5, wherein transferring the feature maps comprises:
extracting the feature map from a final block constituting each of a DOWN-1 stage and an UP-3 stage of the denoising U-Net model, and extracting the feature map from a self-attention layer of a transformer block group in each of stages other than the DOWN-1 stage and the UP-3 stage.

8. The method of claim 7, wherein transferring the feature maps further comprises:
extracting the feature maps by selecting transformer blocks corresponding to a size of the reduced depth from each of the transformer block groups of the teacher model in the DOWN-3 stage, the MID stage, and the UP-1 stage of the denoising U-Net model.

9. The method of claim 8, wherein transferring the feature maps further comprises:
extracting the feature maps by sequentially selecting the transformer blocks corresponding to the size of the reduced depth starting from a first block among the transformer blocks constituting the transformer block group.

10. The method of claim 6, wherein the loss value corresponds to a sum of a first loss value corresponding to a result of a comparison between a noise generated by the lightweight model and a ground truth noise, a second loss value corresponding to a result of a comparison between noises of the teacher model and the lightweight model, and a third loss value corresponding to a result of a comparison between mean square values of differences between the feature maps extracted from the teacher model and the feature maps extracted from the lightweight model.

11. An apparatus for lightweighting a text-to-image generation model, comprising:
a processor configured to construct a lightweight model by pruning and changing a part of blocks in a text-to-image generation model, and train the lightweight model based on self-attention knowledge distillation using a teacher model; and
a memory configured to store the teacher model and the lightweight model.

12. The apparatus of claim 11, wherein each of the text-to-image generation model and the teacher model corresponds to a transformer-based diffusion model including a self-attention operation.

13. The apparatus of claim 12, wherein the processor is configured to:
prune a pair of one residual block and one transformer block group from a DOWN-2 stage and a DOWN-3 stage corresponding to an encoder part, and an UP-1 stage and an UP-2 stage corresponding to a decoder part in a denoising U-Net model that is an internal neural network structure of the text-to-image generation model, and
change a transformer block group included in each of the DOWN-3 stage, an MID stage and the UP-1 stage of the denoising U-Net model to a transformer block group having a reduced depth.

14. The apparatus of claim 13, wherein the lightweight model corresponds to any one of a KD-SDXL-1B model changed to a transformer block group having a depth of 6 and a KD-SDML-700M model changed to a transformer block group having a depth of 5.

15. The apparatus of claim 13, wherein the processor is configured to, after freezing weights of the teacher model, extract feature maps for respective stages of the teacher model, and then transfer the feature maps to the lightweight model.

16. The apparatus of claim 15, wherein the processor is configured to train the lightweight model based on a mean square error (MSE) loss function so as to minimize a loss value calculated for the feature maps.

17. The apparatus of claim 15, wherein the processor is configured to extract the feature map from a final block constituting each of a DOWN-1 stage and an UP-3 stage of the denoising U-Net model, and extract the feature map from a self-attention layer of a transformer block group in each of stages other than the DOWN-1 stage and the UP-3 stage.

18. The apparatus of claim 17, wherein the processor is configured to extract the feature maps by selecting transformer blocks corresponding to a size of the reduced depth from each of the transformer block groups of the teacher model in the DOWN-3 stage, the MID stage, and the UP-1 stage of the denoising U-Net model.

19. The apparatus of claim 18, wherein the processor is configured to extract the feature maps by sequentially selecting the transformer blocks corresponding to the size of the reduced depth starting from a first block among the transformer blocks constituting the transformer block group.

20. The apparatus of claim 16, wherein the loss value corresponds to a sum of a first loss value corresponding to a result of a comparison between a noise generated by the lightweight model and a ground truth noise, a second loss value corresponding to a result of a comparison between noises of the teacher model and the lightweight model, and a third loss value corresponding to a result of a comparison between mean square values of differences between the feature maps extracted from the teacher model and the feature maps extracted from the lightweight model.
